(19) United States
(12) Patent Application Publication
(10) Pub. No.: US 2021/0060731 A1
(43) Pub. Date: Mar. 4, 2021

(54) SYSTEM AND METHOD FOR ABRADING SURFACE OF PLANT

(71) Applicant: Monsanto Technology LLC, St. Louis, MO (US)

(72) Inventors: Bill Hendrix, West Sacramento, CA (US); Paul Hoffer, Sacramento, CA (US); Rick A. Sanders, Redding, CA (US)

(21) Appl. No.: 17/051,120

(22) PCT Filed: Apr. 26, 2019
(86) PCT No.: PCT/US19/29296

§ 371 Date: Oct. 27, 2020

Related U.S. Application Data
(60) Provisional application No. 62/663,746, filed on Apr. 27, 2018.

(51) Int. Cl. B24C 3/32; B24C 3/06; B05B 7/14; B05B 13/04; B05B 15/18; B05B 1/04

(52) U.S. Cl. CPC B24C 3/32; B24C 3/06; B05B 7/1486; B05B 1/042; B05B 13/041; B05B 15/18; B05B 7/1463

(57) ABSTRACT

An abrasion device for abrading a surface of a plant includes a sprayer configured to spray abrasive particles toward the surface of the plant so that the abrasive particles abrade the surface of the plant. A track assembly supports the sprayer thereon. The track assembly defines a path along which the sprayer moves as the sprayer sprays abrasive particles toward the surface of the plant.

### FIELD OF DISCLOSURE

The present disclosure generally relates to a system and method for abrading the surface of a plant, and more specifically, a particle spraying system and method for abrading the surface of the plant.

### BACKGROUND

One method of delivering a treatment to the cells of a plant is through abrasion—marring or scoring the surface of the plant to create pathways into the plants cells. To deliver a particular treatment to the plant's cells, the treatment is applied to the surface of the plant and then the surface is marred to open the plant's cells so that the treatment (e.g. compound) can be absorbed by the cells.

### SUMMARY

In one aspect, an abrasion device for abrading a surface of a plant comprises a sprayer configured to spray abrasive particles toward the surface of the plant so that the abrasive particles abrade the surface of the plant and a track assembly supporting the sprayer thereon. The track assembly defines a path along which the sprayer moves as the sprayer sprays abrasive particles toward the surface of the plant.

In another aspect, a method for abrading surfaces of one or more plants comprises moving a sprayer along a path and spraying, simultaneously with the moving of the sprayer, abrasive particles from the sprayer toward the surfaces of the one or more plants so that the abrasive particles abrade the surfaces of the one or more plants.

Other objects and features of the present disclosure will be in part apparent and in part pointed out hereinafter.

### BRIEF DESCRIPTION OF THE DRAWING

FIG. 1 is a perspective of an abrasion device mounted inside a cabinet:

FIG. 2 is a perspective of a sprayer of the abrasion device of FIG. 1;

FIG. 3 is an enlarged perspective of the sprayer;

FIG. 4 is a perspective of one embodiment of a nozzle of the sprayer;

FIG. 5 is a perspective of the cabinet;

FIG. 6 is an enlarged perspective of the abrasion device; and

FIG. 7 is an enlarged perspective of a portion of a track assembly of the abrasion device.

Corresponding reference characters indicate corresponding parts throughout the drawings.

### DETAILED DESCRIPTION

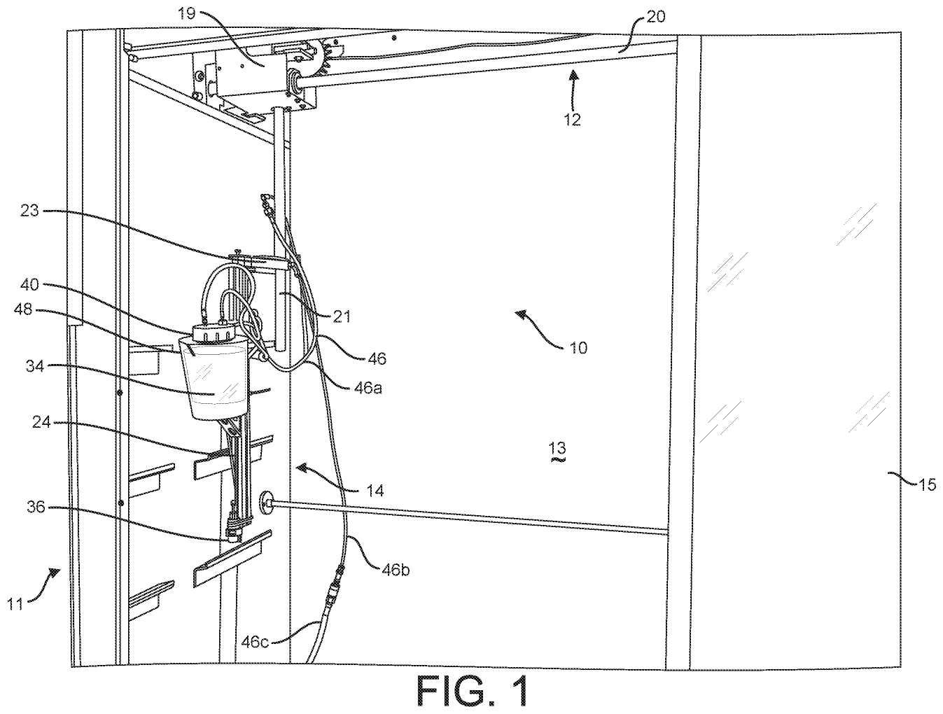

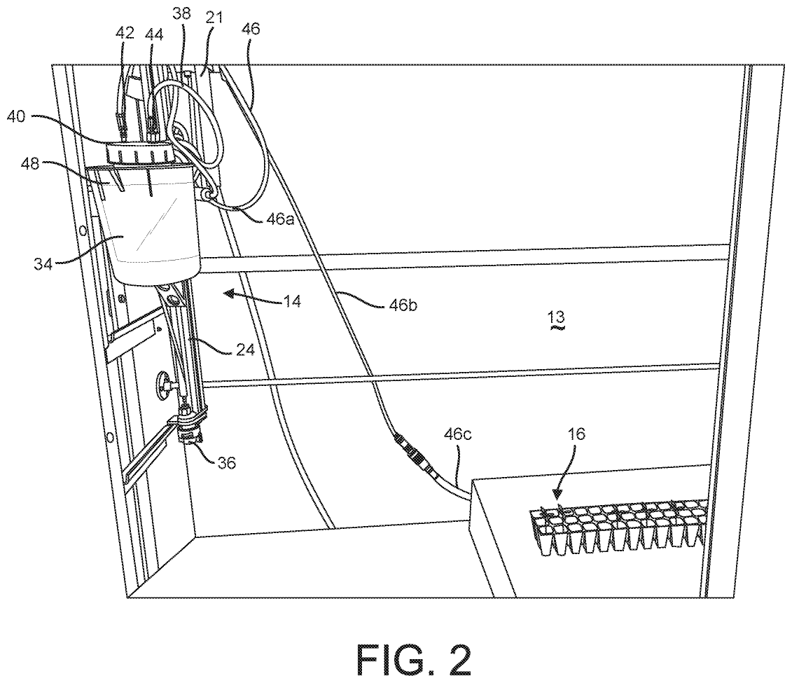

Referring to FIGS. 1 and 2, an abrasion device is indicated generally at 10. The abrasion device 10 is configured to abrade a surface of a plant 16 (FIG. 2). In particular, the abrasion device 10 is configured to spray abrasive particles toward a plant 16, such as leaves or other soft tissue of the plant, to abrade an outer surface of the plant so an applied treatment (such as double stranded RNA) can enter the plant through the abraded surface and be absorbed by the plant's cells. The illustrated abrasion device 10 comprises a track or guide assembly 12 and a particle sprayer, generally indicated at 14, mounted on the track assembly and movable along at least one path or track.

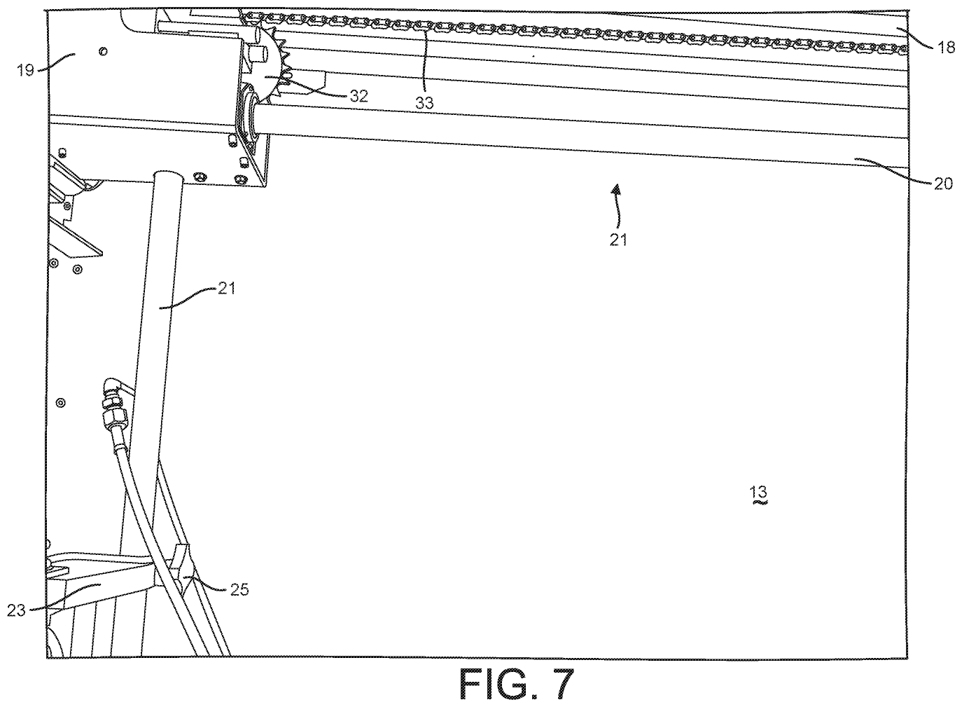

Referring to FIGS. 1, 5, and 7, the abrasion device 10 is mounted within a cabinet 11 that defines an enclosed interior space 13. Sliding glass doors 15 on the front of the cabinet 11 provide access to the interior space 13. The track assembly 12 is mounted adjacent the upper end (e.g., ceiling) of the cabinet 11. In the illustrated embodiment, the track assembly 12 comprises upper and lower rails 18 and 20, respectively (broadly, at least one rail). The upper and lower rails 18, 20 extend between and are connected to (e.g., supported by) opposite side walls of the cabinet 11. The upper and lower rails 18, 20 may comprise elongate rods with a cylindrical shape (as shown), or may be of other shapes. The track assembly 12 defines a path the particle sprayer 14 moves along. More specifically, the upper and lower rails 18, 20 define a horizontal path or track through the interior space 13 of the cabinet 11, along which the particle sprayer 14, which depends from the rails, is movable along the path. As described in more detail below, plants 16 are placed within the interior space 13 of the cabinet 11 such that as the sprayer 14 moves along the path, the abrasive particles sprayed by the sprayer contacts the plants (FIG. 2). In other words, the path is proximal to the plants 16 to be abraded so that as the sprayer 14 moves along the path, the sprayer sprays the abrasive particles toward each plant the sprayer passes. It is understood the abrasion device may be mounted in other ways. For example, in one embodiment, the abrasion device 10 may not be mounted within the cabinet 11, but instead, the track assembly 12 may be supported by supports (which may be movable) at either end. In this example, the supports would be positioned such that the path defined by the track assembly 12 is proximate the plants 16 to be abraded, such as a row of plants (broadly, one or more plants).

Referring to FIGS. 1, 2, 6 and 7, the track assembly 12 also includes a carriage 19 movably connected to (e.g., slidably mounted on) the upper and lower rails 18, 20 and configured to move along the path defined by the rails 18, 20. In the illustrated embodiment, the carriage 19 is longitudinally movable or slidable along the horizontal path defined by the upper and lower rails 18, 20 within the cabinet 11. A support rod 21 of the track assembly 12 extends below the carriage 19. The support rod 21 has a cylindrical shape, or may be of other shapes. The support rod 21 defines a longitudinal axis along its length, which is oriented generally vertically.

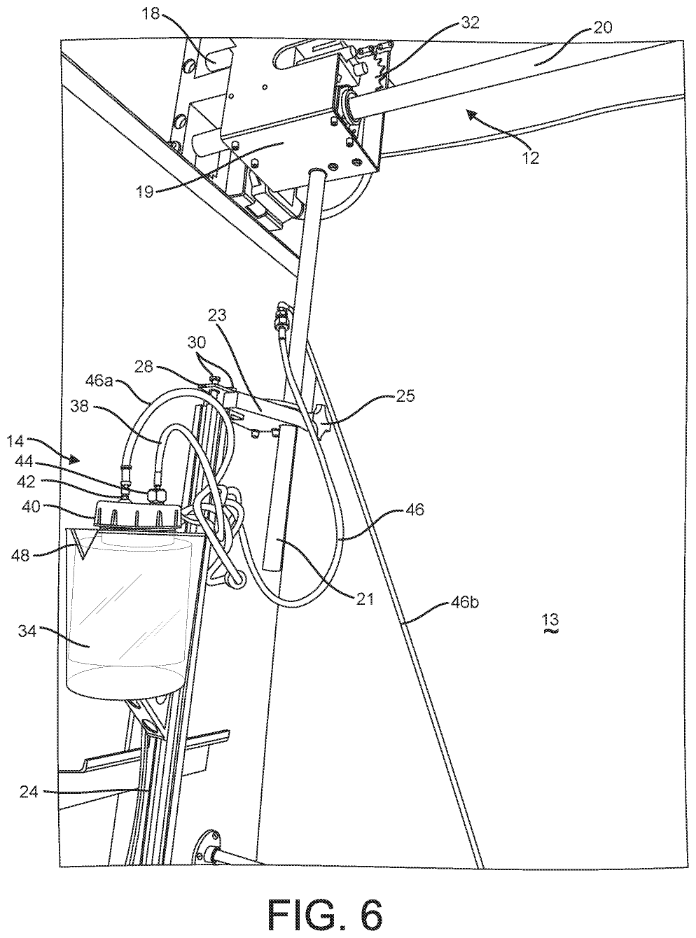

The particle sprayer 14 is mounted on the track assembly 12 by way of a mounting bracket 24 connected to the support rod 21 of the carriage 19 via an intermediate connector 23 (e.g., a horizontal intermediate connector). The mounting bracket 24 is configured to support the particle sprayer 14 thereon. That is, the sprayer 14 is mounted on the mounting bracket 24, and the mounting bracket 24 is, in turn, mounted on the track assembly 12 via the intermediate connector 23 secured to the carriage 19. The upper portion of the mounting bracket 24 includes an attachment mechanism for coupling the mounting bracket to the intermediate connector 23. The attachment mechanism includes a plate 28 connected to the upper end of the mounting bracket 24 with two fasteners 30 (e.g., screws). To connect the mounting bracket 24 to the intermediate connector 23, the two fasteners 30 (with at least one fastener extending through the intermediate connector) are tightened to clamp the intermediate connector between the plate 28 and the upper end of the mounting bracket 24 (FIG. 6). The intermediate connector 23 defines an opening through which the support rod 21 is received. A knob 25 with a set screw is configured to releasably secure the support rod 21 in the opening when the knob is manually operated (e.g. turned). In the illustrated embodiment, the intermediate connector 23 is shown coupled to the support rod 21 such that the support rod is received in the opening of the intermediate connector. This manner of releasable connection allows the intermediate connector 23 to be selectively positionable longitudinally along the support rod 21 and selectively rotatable on the support rod. Other ways of connecting the intermediate connector 23 to the support rod 21 are within the scope of the present disclosure. It is understood that other ways of connecting the sprayer 14 to the track assembly 12 are within the scope of the present disclosure.

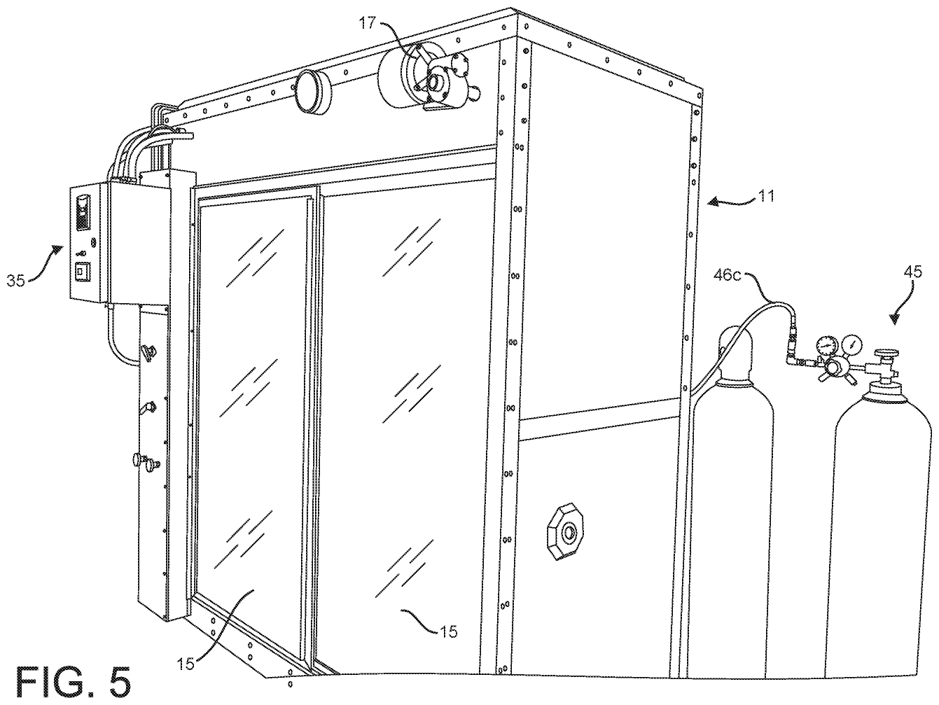

The abrasion device 10 may include a driver 17 (FIG. 5) operatively connected to the carriage 19 and configured to move the carriage along the upper and lower rails 18, 20 (e.g., the path or track). The driver 17 may include a prime mover (e.g., a motor, such as an electric motor). In the illustrated embodiment, the driver 17 is attached to the exterior of the cabinet 11 and drives the movement of a drive train to move the carriage 19. The illustrated drive train operates in a similar manner to chain drive garage door openers, as are generally known, and includes, at least in part, a chain 33 engaging a sprocket 32. The chain 33 extends along the path defined by the upper and lower rails 18, 20 and through the movement of the chain and rotation of the sprocket 32, the driver 17 moves the carriage 19 along the upper and lower rails. Other ways of operatively connecting the driver 17 to the carriage 19 (e.g., the drive train) are within the scope of the present disclosure. The driver 17 may be connected to a controller 35 (FIG. 5) which automatically operates the driver and controls the direction of movement of the carriage 19 as well as the speed at which the carriage is moved along the path. It is appreciated the driver can move the carriage 19, and therefore the sprayer 14, toward either end of the rails 18, 20 (e.g. forward or reverse). In one or more embodiments, the carriage 19 and/or the sprayer 14 may be driven or moved along the path in other ways.

Referring to FIGS. 1-3 and 6, the particle sprayer 14 comprises a container 34 and a nozzle 36. The container 34 is generally known in the art and defines an interior configured to hold or receive the abrasion particles. The container 34 includes a removable lid 40 (e.g., the container is resealable). In the illustrated embodiment, the lid 40 is threaded onto the container 34. For reasons that will become apparent, the lid 40 forms a fluid (e.g., air) tight seal with the container 34. The lid 40 includes an inlet fitting 42 and an outlet fitting 44. The inlet fitting 42 defines an inlet to the interior and the outlet fitting 44 defines an outlet to the interior. The inlet fitting 42 is configured to connect to a pressure source 45 (FIG. 5), such as an air compressor or a compressed air tank. In particular, the inlet fitting 42 is configured to connect to a flexible line 46 connected to the pressure source 35 and the container 34. In the illustrated embodiment, flexible line 46 includes flexible line sections 46a, 46b and 46c connected together to fluidly connect the pressure source 45 to the inlet fitting 42. The inlet provides fluid communication between the pressure source 45, via a conduit of the flexible line 46, and the interior of the container 34. The outlet fitting 44 is configured to connect to another flexible line 38. The flexible line 38 is connected to the outlet fitting 44 at one end and the nozzle 36 at the other. The flexible line 38 defines a conduit that provides fluid communication between the nozzle 36 and the interior of the container 34. As described in more detail below, the pressure source 45 delivers a pressurized stream of fluid (e.g. compressed air) into the interior of the container 34 to move the abrasion particles from the container 34, through the nozzle 36 and into contact with the plant 16. The inner workings of the container 34 and how the stream of pressurized fluid moves particles from the interior of the container are generally known in the art.

Referring to FIG. 4, the nozzle 36 is configured to resist the abrasive effects of the abrasion particles as the particles are moved through the nozzle by the pressure source. The nozzle 36 includes an insert 50 that protects the nozzle from the abrasive particles (e.g. resists the abrasive nature of the particles). The insert 50 can be made of tungsten carbide or any other suitable material. The insert 50 defines the outlet of the nozzle 36 and, thus, the spray pattern of the abrasive particles as the particles exit the nozzle. In one embodiment, the nozzle 36 is configured to create a wide angle flat spray pattern with a spray angle between about 75 and about 115°, and more preferably about 95° (e.g. the insert 50 creates the flat spray pattern). Other nozzles and/or inserts with different spray patterns and configurations are within the scope of the present disclosure.

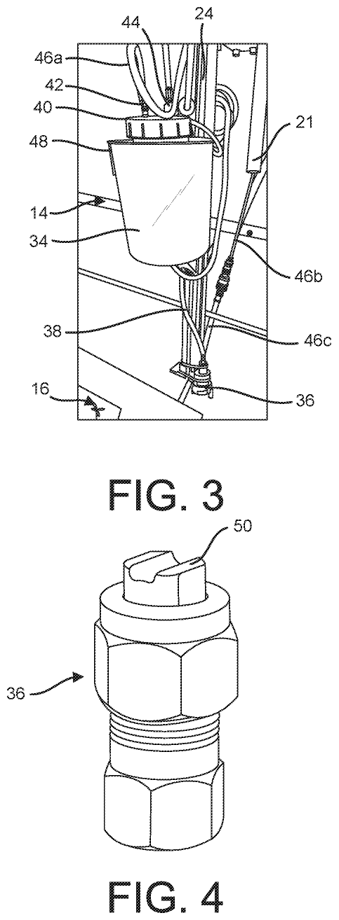

Referring to FIGS. 2 and 3, the container 34 and nozzle 36 are connected to and supported by the mounting bracket 24. In the illustrated embodiment, a holder or bucket 48 is secured to the mounting bracket 24 and the container 34 is removably received in and supported by the bucket. The nozzle 36 is secured to the lower portion of the mounting bracket 24 at a location spaced apart from the container 34. The nozzle 36 is configured to direct the abrasive particle toward the surface of the plants 16. In the illustrated embodiment, the nozzle 36 is oriented to direct the abrasive particles downward. In one embodiment, a position of the sprayer 14, such as a component thereof, on the mounting bracket 24 may be adjustable. For example, one or both of the container 34 and the nozzle 36 may be movable secured to the mounting bracket 24 to allow the heightwise and/or lateral position of the container and/or nozzle to be adjustable. Similarly, the position of the intermediate connector 23 on the support rod 21 can be changed to adjust the position of the sprayer 14. In a particular embodiment, the mounting bracket 24 may include a vertical and/or lateral track on which holder or bucket 48 and/or the nozzle 36 is movable connected. Other ways of connecting the container 34 and nozzle 36 to the mounting bracket 24 are within the scope of the present disclosure.

The abrasion particles can be formed from any suitable material, including, but not limited to, silicon carbide and/or diatomaceous earth. In one embodiment, the abrasion particles have a size of 220 mesh. Other sizes of the abrasion particles are within the scope of the disclosure.

In use, as shown in FIG. 2, the plants 16 are placed in the interior space 13 such that the abrasion device 10 is positioned proximal to the plants 16, such as a row of plants. The plant or plants 16 are positioned such that the upper and lower rails 18, 20 are above the plants to be abraded (e.g. the upper and lower rails define a path or track above the plants). In the illustrated embodiment, where the path is in a fixed position within the cabinet 11, the user may position the plants 16 within the cabinet so that the abrasive particles sprayed by the sprayer 14 come into contact with the plants as the sprayer moves along the path. In other embodiments, the track assembly 12, mounting bracket 24 and/or sprayer 14 may be positioned relative to the plants 16 in other manners. In other words, the path is proximal to the row of plants 16 so that the sprayer moves along (e.g., over, above, proximal to, adjacent to, beside, alongside) the row and sprays the plants in the row with abrasion particles. The user then removes the lid 40 and places the abrasion particles into the interior of the container. The lid 40 is then threaded onto the container 34, closing the interior and forming a fluid tight fight with the container. The flexible line 46 is connected to the pressure source 45 at one end and the inlet fitting 42 at the other end. The flexible line 46 has a length that is long enough to allow the particle sprayer 14 to move to both ends of the path. The flexible line 38 is connected to the outlet fitting 44 at one end and the nozzle 36 at the other end. To abrade the surface of the plants 16, the controller 35 may operate the driver 17, moving the particle sprayer 14 along the upper and lower rails 18, 20 (e.g. along the path) via the carriage 19. As the particle sprayer 14 moves along the path, the pressure source 45 delivers or supplies a stream of pressurized air into the interior of the container 34. The pressurized air forces or moves the abrasive particles within the container 34 through the outlet, into the flexible line 38 and out of the nozzle 36. As the abrasive particles spray out of the nozzle 36, the nozzle 36 directs the abrasive particles toward the plants 16. In the illustrated embodiment, the track assembly 12 and particle sprayer 14 are positioned directly above the plants 16 such that the nozzle 36 directs the particles downward. It is understood the nozzle 36 can direct the abrasion particles in other directions than described herein such that the track assembly 12 and particle sprayer 14 may have other positions relative to the plants 16.

The pressurized air from the pressure source sprays the abrasive particles from the nozzle 36 with a sufficient velocity such that when the particles come into contact with the leaves (more broadly, soft tissue) of the plants, the abrasive particles abrade the plants' surfaces, such as the leaves of the plants. For example, in one embodiment the user can apply a treatment to the plants and then the abrasion device 10 sprays the abrasive particles at a rate of 0.3 g/s (1.14 l/s) to abrade the surface of the plant so the treatment is absorbed.

The abrasion device 10 is adjustable and can be configured to the particular needs of the user and the plants 16 to be abraded. The track assembly 12 can be adjusted to vary the height or distance between the nozzle 36 and the plants 16. For example, the upper and lower rails 18, 20 can be moved closer or further from the plants 16, and/or the sprayer 14 (e.g., a component thereof) can be vertically adjusted relative to the mounting bracket 24, and/or the mounting bracket can be vertically adjusted relative to the carriage 19. The controller can vary the speed at which the driver moves the sprayer 14 along the path, therefore varying the amount of abrasive particles hitting the plants 16. The spray angle and/or pattern formed by the nozzle 36 can also be changed. For example, in the illustrated embodiment, a wide angle flat spray pattern is created by the nozzle 36, however, other spray angles and/or patterns such as, but not limited to, a hollow cone or a full cone spray pattern are within the scope of the present disclosure. The nozzle 36 can also be changed to vary the amount or volume of abrasive particles that exit the particle sprayer 14. By controlling the pressure supplied by the pressure source, the velocity at which the abrasive particles exit the nozzle 36 can be controlled. By varying or changing these parameters of the abrasion device 10, the degree and severity of the abrasion applied to the plants 16 can be adjusted. Accordingly, the abrasion device 10 can be adapted to abrade a wide variety of different plant species.

Because the particle sprayer 14 is mounted on the track assembly 12, the abrasion device 10 can apply consistent abrasion between plants 16. The consistent and reproducible application of abrasive particles to the plant's 16 surface (e.g. a consistent abrading of the plant's surface between plants) enables treatments to be consistently applied to every plant. In other words, because all the plants are abraded to a similar degree by the abrasion device 10, when the treatment is applied, it is believed all the plants 16 will substantially absorb a similar amount of treatment. This believed reproducibility and consistency between treatments allows the effectiveness of the treatments to be evaluated more effectively. Previous methods of abrading the surface of a plant were done by hand, which created inconsistencies and differences between the abrasions applied between plants. Accordingly, under previous methods, each plant absorbed a different amount of treatment-making it difficult to determine the effectiveness of the treatment.

In view of the above, it will be seen that several advantageous results are obtained.

Having described the invention in detail, it will be apparent that modifications and variations are possible without departing from the scope of the invention defined in the appended claims.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained. As various changes could be made in the above constructions and methods without departing from the scope of the invention, it is intended that all matter contained in the above description and shown in the accompanying drawings shall be interpreted as illustrative and not in a limiting sense.

1. An abrasion device for abrading a surface of a plant, the abrasion device comprising:
a sprayer configured to spray abrasive particles toward the surface of the plant so that the abrasive particles abrade the surface of the plant; and
a track assembly supporting the sprayer thereon, the track assembly defining a path along which the sprayer moves as the sprayer sprays abrasive particles toward the surface of the plant.

2. The abrasion device of claim 1, wherein the sprayer further comprises a resealable container defining an interior configured to hold the abrasion particles.

3. The abrasion device of claim 2, wherein the sprayer further comprises a nozzle in fluid communication with the container, the nozzle configured to direct the abrasive particles toward the plant as the abrasive particles are sprayed by the sprayer.

4. The abrasion device of claim 3, wherein the nozzle further includes an insert configured to protect the nozzle from the abrasive particles.

5. The abrasion device of claim 3, wherein the nozzle has a spray angle between 75° and 115°.

6. The abrasion device of claim 1, wherein the track assembly comprises at least one rail, the at least one rail defining the path.

7. The abrasion device of claim 6, wherein the track assembly further includes a carriage movably mounted on the at least one rail, the sprayer being connected to the carriage.

8. The abrasion device of claim 7, further comprising a mounting bracket connected to the carriage, the sprayer mounted on the mounting bracket.

9. The abrasion device of claim 8, wherein the mounting bracket is selectively movable in relation to the carriage.

10. The abrasion device of claim 1, wherein the track assembly further includes a driver configured to move the sprayer along the path.

11. The abrasion device of claim 1, further comprising a pressure source fluidly connected to the sprayer.

12. The abrasion device of claim 1, further comprising a cabinet defining an interior, the sprayer and track assembly disposed within the interior of the cabinet.

13. A method for abrading surfaces of one or more plants, the method comprising:
moving a sprayer along a path;
spraying, simultaneously with the moving of the sprayer, abrasive particles from the sprayer toward the surfaces of the one or more plants so that the abrasive particles abrade the surfaces of the one or more plants.

14. The method of claim 13, wherein the path is defined by at least one rail.

15. The method of claim 13, wherein the one or more plants are arranged in a row and the path is proximal to the row so that the sprayer moves along the row.
